(19) United States
(12) Patent Application Publication
(10) Pub. No.: US 2023/0309477 A1
(43) Pub. Date: Oct. 5, 2023

(54) AUTOMATED VERTICAL MICRO-FARM

(71) Applicant: Laurus Inc., Wilmington, DE (US)

(72) Inventors: Nicolas Bisso URRUTIGOITY, Buenos Aires (AR); Federico Andres HOJMAN GANDOLFO, Caba (AR); Tomas GIRAUDY, Río Negro (AR); Juan MOLLICA, Buenos Aires (AR); Marcos BRITO DEVOTO, Buenos Aires (AR)

(21) Appl. No.: 18/130,310

(22) Filed: Apr. 3, 2023

Related U.S. Application Data
(60) Provisional application No. 63/327,238, filed on Apr. 4, 2022.

(51) Int. Cl. A01G 31/06; A01G 31/04; A01D 91/04

(52) U.S. Cl. CPC A01G 31/06; A01G 31/045; A01D 91/04

(57) ABSTRACT

A vertical micro-farm system, the system may include an external structure; a nursery positioned inside the external structure for an initial growth process; a plurality of grow towers inside the external structure for a second growth process; an autonomous robot configured to move baby plants from the nursery to the plurality of grow towers after completion of the first growth process; and a produce processing and packing machine for receiving matured plants for processing after the baby plants have completed the second growth process in the plurality of grow towers, wherein the matured plants are transferred from the plurality of grow towers to the produce processing and packing machine by the autonomous robot.

### BACKGROUND

This application claims priority under 35 U.S.C. 119(a) to U.S. Provisional Application No. 63/327,238, filed on Apr. 4, 2022, the content of which is incorporated herein in its entirety for all purposes.

### FIELD

The present disclosure is generally directed to a method and a system for micro-farming.

### RELATED ART

Greenhouses have emerged as a solution to the ever-growing need for food supplies and the lack of resources. While greenhouses have allowed large-scale plant production, the same greenhouses are typically extensive structures that require a minimum footprint of 2500 m² and costly in nature.

Various forms of farming emerged to tackle challenges associated with farming environments and conditions, with vertical farming being one of them. Vertical farming usually occurs on trays, shelves, or racks. The system does come with certain disadvantages such as complexity in irrigation, large structural footprint, and available space for plants.

While existing vertical farms allow for compact vertical alignment where plants are arranged in a wall-like setting as opposed to horizontal shelves, these towers are expensive and require skilled labor to operate. This includes seed placement and plant removal.

Furthermore, automation in vertical farming operation becomes extremely complex. The handling of the plants involves removing the tower from its natural vertical position, placing it on a surface, and requiring careful handling of the towers and plants. While robotic arms may handle the positioning of towers, the robotic arms, however, are incapable of handling the plants directly and are costly.

A need exists for a new form of micro-farming that is both cost-efficient and highly scalable.

### SUMMARY

The vertical micro-farm provided herein is a cost-efficient controlled environment agriculture (CEA) development designed for urban farming. The irrigation system is automated, no matter the degree of automation on the rest of the farm. The farm can operate autonomously or be manually/human operated, depending on the user's needs. Thus, the various operations of planting, harvesting, plant moving, cutting, washing, and packing operations can be performed by either people, robots, or a combination of both. The lightweight design and small footprint allow the vertical micro-farm to be installed on soil, concrete floors, rooftops, and other flat surfaces. The farm is equipped to produce high-quality vegetables from the seeding, and get them ready for pick-up and packaging through an automated process.

Aspects of the present disclosure involve an innovative vertical micro-farm system. The system may include an external structure; a nursery positioned inside the external structure for an initial growth process; a plurality of grow towers inside the external structure for a second growth process; an autonomous robot configured to move baby plants from the nursery to the plurality of grow towers after completion of the initial growth process; and a produce processing and packing machine for receiving matured plants for processing after the baby plants have completed the second growth process in the plurality of grow towers, wherein the matured plants are transferred from the plurality of grow towers to the produce processing and packing machine by the autonomous robot.

Aspects of the present disclosure involve an innovative method for growing and harvesting plants in a micro-farm. The method may include receiving seed trays at the micro-farm, wherein each seed trays contains seeds; feeding the seed trays into a nursery, and growing the seeds to baby plants at the nursery; transferring, by an autonomous robot, the baby plants from the nursery to at least one grow tower, wherein the baby plants grow into the plants at the at least one grow tower; and transferring, by the autonomous robot, at least one of the plants from the at least one grow tower to a produce processing and packing machine for harvesting.

Aspects of the present disclosure involve an innovative system for growing and harvesting plants in a micro-farm. The system may include means for receiving seed trays at the micro-farm, wherein each seed tray contains seeds; means for feeding the seed trays into a nursery, and growing the seeds to baby plants at the nursery; means for transferring, by an autonomous robot, the baby plants from the nursery to at least one grow tower, wherein the baby plants grow into the plants at the at least one grow tower; and means for transferring, by the autonomous robot, at least one of the plants from the at least one grow tower to a produce processing and packing machine for harvesting.

### BRIEF DESCRIPTION OF THE DRAWINGS

Various embodiments in accordance with the present disclosure will be described with reference to the drawings, in which:

FIG. 1 illustrates a top view of the vertical micro-farm's internal structure, according to an embodiment.

FIG. 2 illustrates a side view of process vertical micro-farm's internal structure as depicted in FIG. 1.

FIG. 3 illustrates an example process flow of operations in the vertical micro-farm, according to an embodiment.

FIG. 4 illustrates a perspective view of an external structure of the vertical micro-farm, according to an embodiment.

FIGS. 5(a)-(d) illustrate example processes of seedling/micro-green growth system, according to various embodiments.

FIG. 6 illustrates a perspective view of a nursery conveyor system, according to an embodiment.

FIG. 7 illustrates a perspective view of a grow tower, according to an embodiment.

FIG. 8 illustrates inner components of a grow tower as depicted in FIG. 7.

FIG. 9 illustrates a perspective view of a polyethylene sheet, according to an embodiment.

FIG. 10 illustrates a perspective view of the grow tower system, according to an embodiment.

FIG. 11 illustrates a top view of the grow tower system as depicted in FIG. 10.

FIG. 12 illustrates a perspective view of a pick and place robot operating over the grow tower system as depicted in FIG. 10.

FIG. 13 illustrates the components to the pick and place robot in movement axes X and Z, according to an embodiment.

FIG. 14 illustrates a perspective view of an end effector, according to an embodiment.

FIG. 15 illustrates a perspective view of a produce processing and packing machine, according to an embodiment.

FIG. 16 illustrates a perspective view of a root cutting module.

### DETAILED DESCRIPTION

The following detailed description provides further details of the figures and example implementations of the present specification. Terms used throughout the description are provided as examples and are not intended to be limiting. For example, the use of the terms “automated” and “automatic” may involve fully automatic or semi-automatic implementations involving user or operator control over certain aspects of the implementation, depending on the desired implementation of one of ordinary skill in the art practicing implementations of the present application.

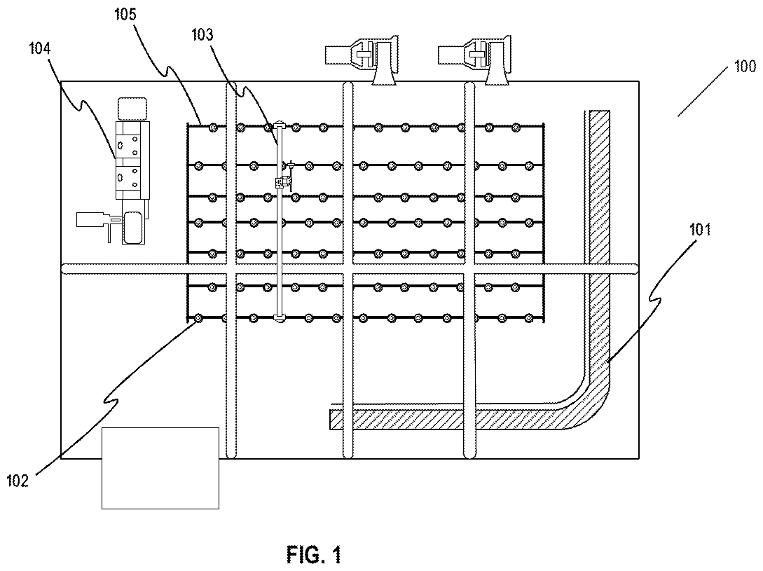

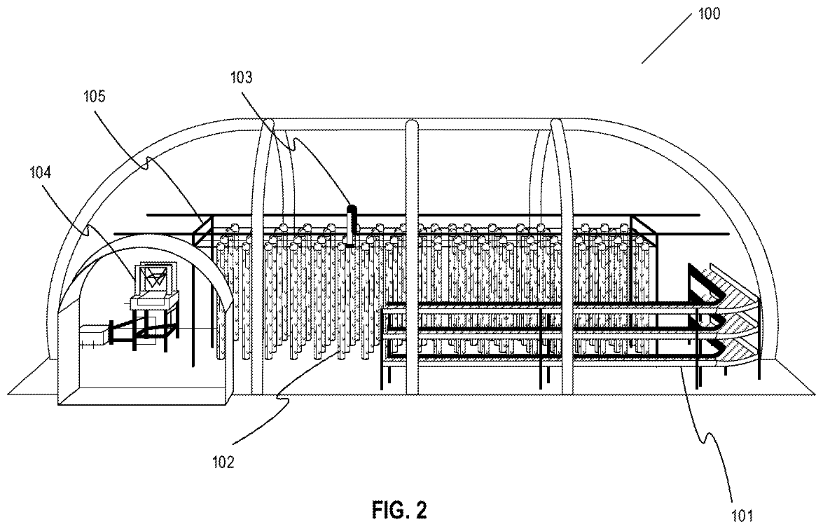

Example embodiments of a vertical micro-farm and air-dome are described. FIG. 1 illustrates a top view of the vertical micro-farm's internal structure 100, in accordance with an example embodiment. The vertical micro-farm's internal structure 100 may include components such as a nursery 101, grow towers 102, a pick and place robot 103, a produce processing and packing machine 104, and a tower frame 105. The various components are described in details below. FIG. 2 presents a side view of the vertical-farm's internal structure 100, in accordance with an example embodiment.

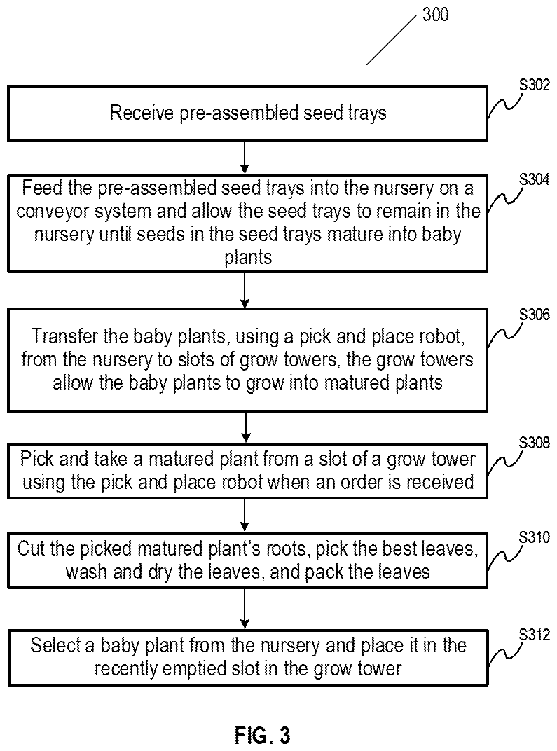

The micro-farm's operations can be divided into two broad categories: actions taken when a purchase is made and actions taken for plant growth or restocking. FIG. 3 illustrates an example process flow 300 of operations in the vertical micro-farm, according to an embodiment.

At step S302, pre-assembled seed trays bearing seeds arrive and are received at the micro-farm, where they are fed into the nursery 101 on a conveyor system, that forms a part of the nursery 101 at step S304. The seeds will sprout and begin their initial growth process/stage, which lasts approximately 30 days, until they become baby plants in the nursery 101. At step S306, the baby plants are then transferred by the pick and place robot 103 from the nursery to the growing area where the grow towers 102 are located. The baby plants are then placed into the grow towers 102, where they will remain for approximately 30 days to complete the second growth process/final growth cycle and grow into matured plants. The grow towers 102 have slots for baby plants to be inserted by the pick and place robot 103. If all slots are occupied, the pick and place robot 103 will stop the filling process and resume activity when a purchase is made, which results in emptying of a slot. When a seed tray is emptied, it is removed from the nursery 101 for pick-up and reuse, and the micro-farm restocks the trays with new seeds.

At step S308, when an order for a ready-to-eat salad is received at the micro-farm, the pick and place robot 103 identifies and picks a plant that has completed its growth cycle in a grow tower 102 and takes it to the produce processing and packing machine 104, where it will be prepared/harvested for pickup or delivery. At step S310, the produce processing and packing machine 104 will cut the plant's root off, pick the best leaves, wash and dry the leaves, and pack a ready-to-eat salad. At step S312, while the packing occurs, the pick and place robot 103 will select a baby plant from the nursery 101, and place it in the recently emptied slot in the grow tower 102, where the previous plant was taken from. If the purchase is for baby leaves, microgreens, or plants not requiring the additional growth cycle in the grow towers 102, the plant is taken directly from the nursery 101 to the produce processing and packing machine 104 for processing by the pick and place robot 103.

The farm can be subdivided into eight sub-systems:
External structure;
Internal insulation;
Seedling/micro-green growth system;
Grow towers and vine fruit growth systems;
Pick and place robot;
Produce processing and packing machine;
Climate control; and
Backup systems

External Structure

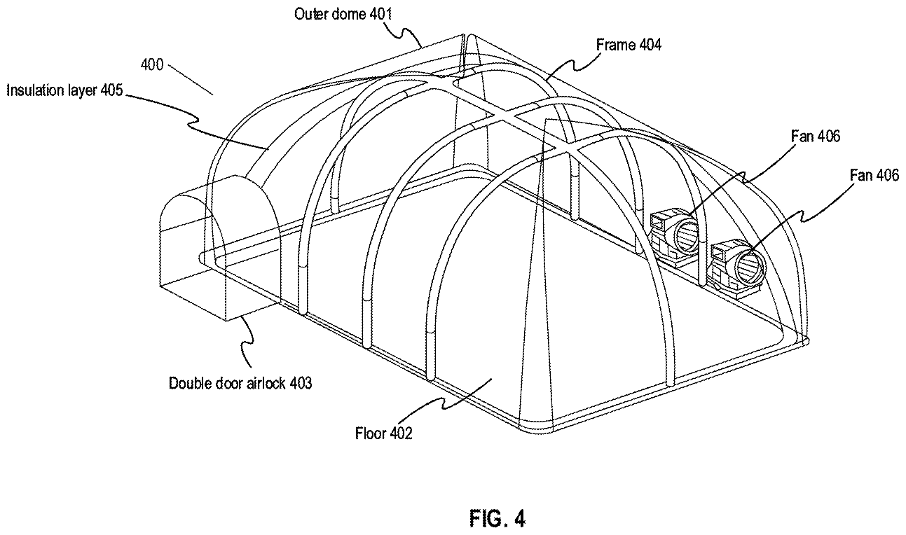

FIG. 4 illustrates a perspective view of the vertical micro-farm's external structure 400, in accordance with an example embodiment. As shown in FIG. 4, the farm is housed by a pneumatic external structure 400, also known as air-supported structure or air dome. The external structure 400 comprises an outer dome 401, a floor 402, a double door airlock 403, a frame 404, an insulation layer 405, and a plurality of fans 406. In some example embodiments, the external structure 400 has a rectangular footprint of approximately 150 m² (1614.6 square ft), a maximum height of 7 m (23 ft), and a height of 5 m (16.4 ft). The footprint can be expanded for windy locations requiring larger fans or locations requiring HVAC systems to handle extreme temperatures. The small footprint allows the vertical micro-farm to be installed on surfaces such as soil, concrete floors, rooftops, and other flat surfaces.

The outer dome 401 may include at least one plastic film, which can be made of thermoplastic polyurethane (TPU) or polyvinyl chloride (PVC) through radio frequency (RF) or thermally-welded seams, with a thickness in the range of 0.1 to 3 mm. In an embodiment, the outer dome 401 is double layered with an air-gap. The film can be transparent/clear or translucent with different colored tints, polarization, or filters to achieve optical properties. The outer dome 401 has reinforcements made with vinyl tarp, which has a textile matrix to achieve better mechanical properties and higher durability. In some example embodiments, the reinforcements comprise plastics and textile materials, welded or sown to the main structure.

The external structure 400 has a floor 402 which is joined to the outer dome 401 by either sewing or welding. Welding provides a tight seal, which avoids pressure loss and upwards force, thereby adds stability to the external structure 400. The floor 402 itself can be either white or reflective on the upward facing surface. In some example embodiments, a lightweight inner skeleton is utilized to aid in stability and ease of initial setup. The skeleton can be made of steel, aluminum, or carbon fiber poles. The poles can be split into smaller pieces, and reassembled through a twist-and-lock system or with threaded ends.

The external structure 400 has a double door airlock 403, which allows entrance into the vertical farm without pressure loss. The doors and airlock forming the double door airlock 403 can be either rigid or flexible. In any case, the doors are airtight. Flexible doors can be closed with zippers, Velcro™, buttons, or a combination of any of the above. In some example embodiments, flaps are added to provide better sealing.

The external structure 400 has steel beams mounted on its edges, which are used as an anchoring system. The beams are drilled and placed on the floor 402, which is in turn supported by the ground. If the farm is placed on a concrete floor, the beams are drilled through and bolted down to the concrete, using standard metal or chemical masonry anchors. If the farm is placed on soil, special anchors are required to support the wind loads.

In some example embodiments, the external structure 400 is covered by a steel cable net in the shape of the outer dome 401. The steel cable net is anchored to the ground and is used to reinforce the plastic structure, making it able to resist windy conditions. The cable net is attached to the same beams that hold the inflatable dome, using bolts, anchor shackles or similar standard fastening methods.

As illustrated in FIG. 4, the external structure 400 includes at least two fans 406. The fans 406 are equipped with valves to avoid flow reversal or pressure loss through idle fans, and run continuously to compensate for pressure loss. The inflation pressure is in the range between 150 Pa (0.02 PSI) and 400 Pa (0.06 PSI) (manometric). This provides sufficient force to maintain the structure upright and resistant to wind loads. In some example embodiments, the fans can have filters to provide for better air quality, which range from coarse particle filters to HEPA filters. In some example embodiments, the air can also be preheated in a heat exchanger or solar collector to lower power consumption during low temperature periods.

The fans 406 direct the air inside in such a way that vortexes are created. The air is mixed and thermal stratification is thereby avoided. The fans 406 can be equipped with pressure sensors and speed controllers to optimize power consumption. In some example embodiments, the fans can be placed inside the dome. This aids with noise reduction towards the environment. In some example embodiments, the fans 406 can be located in an external housing that protects the fans 406 from damages brought about by external elements. In some example embodiments, the fans 406 can also be mounted on flexible bases, which act as vibration dampeners.

Internal Insulation

As illustrated in FIG. 4, inside the weatherproof external structure 400 is an insulation layer 405. The insulation layer 405 serves to thermally insulate the micro-farm while maintaining proper optical characteristics. The insulation layer 405 is held on a frame 404. The frame 404 is composed of sealed, inflatable beam having a round cross section. Unlike the external structure 400 where air is constantly supplied by the fans 406, the beams only need to be inflated once and closed off with a valve to maintain air pressure. In some example embodiments, the frame 404 includes a pressure gauge and a compressor to compensate for small air losses.

The insulation layer 405 is comprised of two layers of transparent or translucent plastic film, which are tangent to the frame 404, with one layer on the outside and another layer on the inside, thus creating a still air gap. This air gap works like a double walled glass and provides the desired insulation for the micro-farm. The air gap thickness ranges between 2 cm to 30 cm. In an embodiment, the insulation layer further comprises optical enhancers, such as tints, filters, and polarized layers. In an embodiment, auxiliary instruments such as smoke machines can be incorporated to create a smoke screen to reduce incident light.

In an embodiment, the insulation layer 405 covers the floor 402 of the external structure 400. This can be achieved by having the insulation layer 405 be part of the air-chambered frame 404 or having an insulating material lining the floor 402.

Seeding and Micro-Green Growth System—Nursery

The first stage of the farm begins with cultivation/growing of seedlings, “baby leafy greens” (a plant that is larger than a seedling, or plug, but smaller than an adult plant), and micro-greens from seeds. All three remain in a growth system within the nursery 101 for approximately 30 days. The growing process is similar for all three, and the system is shared among them. The differences are the trays used and the time it takes to grow each one. The trays are arranged on a conveyor system, which moves the trays along during the plants' growth process, removes empty trays, and inserts new ones. The growth system interfaces with the pick and place robot 103 so that the latter can move plants from the nursery 101 to the grow towers 102.

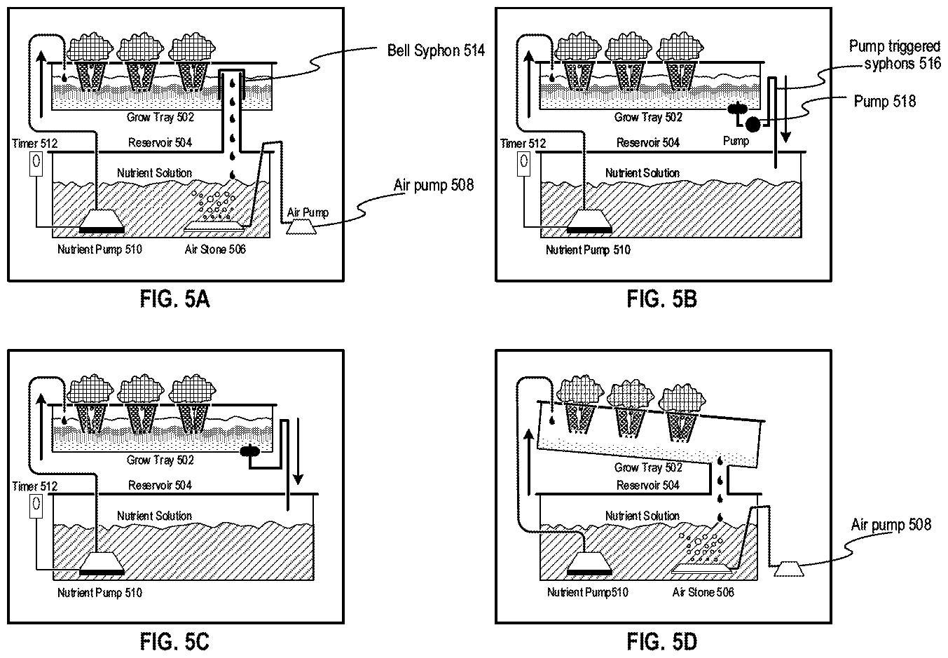

Various embodiments of the growth system are shown in FIGS. 5(a)-(d). The growth system consists of a rack of one to five levels, each containing large deep shelves which hold the grow trays 502. The grow trays 502 are designed for ebb and flow hydroponics, where the water level will rise from below the plants, and then the shelf, or pan, will be emptied/drained. A water quality controller is used to monitor and control the nutrient concentration and pH of the water. A water reservoir 504 for storing nutrient solution or water can be either a regular tank or a flexible bladder tank. The bladder tank can be kept expanded even when the tank is empty. This is achieved by utilizing a light frame for the bladder tank. In an embodiment, an air stone 506 and/or air pump 508 can be installed to provide the water with additional oxygen. Each level on the rack is filled, and the water is then removed to the next level. The irrigation process can begin from the top level, or from the bottom level.

In an embodiment, nutrient solution or water is pumped to the grow tray 502 from the reservoir 504 using a nutrient pump 510. In an embodiment, a timer 512 is used to control/adjust the pumping frequency of the nutrient pump 510, which can be set by an operator. Once the water has risen to the desired level in the grow tray 502, the emptying process can then be initiated, so that the water fills/flows to the level below. This can be achieved in several ways:
1. Bell siphons. As shown in FIG. 5(a), bell siphons 514 are placed on each shelf, with a drainage towards the next level. Once the water reaches a preset level, the bell siphons 514 are then triggered to allow water to flow to the level below. The sequence begins with the pumping of nutrient solution or water to the grow tray 502 and ends when the water returns to the reservoir 504.
2. Pump triggered siphons. As shown in FIG. 5(b), the pump triggered siphons 516 are created by raising the drainage pipe over the water level. A small pump, pump 518, can be placed below the water level for pumping the water out, and activating the pump triggered siphons 516 by filling the pipes. The pump triggered siphons 516 will continue the emptying process until the shelf is empty or a threshold water level is reached.
3. Siphons. As shown in FIG. 5(c), the siphons 520 operate the same way as a passive siphon. The bend of the pipes is designed just at the maximum water level of the grow trays 502.
4. Direct drainage or cascade. As shown in FIG. 5(d), the water enters the grow trays 502 from one side, and leaves from the other. The grow trays 502 are designed to slow the waterflow and allow for proper irrigation to take place across the different levels. At the shelf's bottom level, the water is drained back to the reservoir 504.

In an embodiment, water is pumped directly from the reservoir 504 to fill the bottom level first. Nutrient pumps 510 are placed at the drain of each shelf and will pump nutrient solution or water upwards to the level above. The nutrient pump 510 at the top-level then drains the water back to the reservoir 504.

Seeds are placed on special trays, which have regular spacing that allow the plants to grow independently from each other. The trays have a depth between 1 cm (0.4 in) and 7 cm (2.75 in), and have a drainage system for water to leave the trays from the bottom. The pre-assembled seed trays are prepared outside the farm through standard machinery at a centralized site, and distributed to different greenhouses/micro-farms for use. The pre-assembled seed trays receive the seeds and place them in at least one of three mediums: natural vegetable/cellulose sponges, mycelial sponges or baskets (fungi-based structures), or loose mediums such as coconut shells, perlite or etc., that secure the seeds in the trays. The trays have separators to avoid roots from getting entangled with each other.

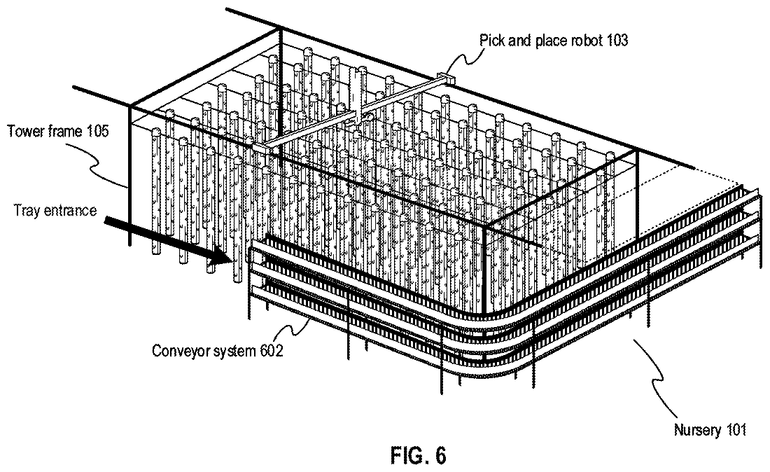

FIG. 6 illustrates an example conveyor system forming as part of the nursery 101, according to one embodiment. The edges of the seedtrays fit on a conveyor system 602 that runs on the shelves of the nursery 101. The seed trays are transported from one end of the conveyer system 602 to the other. At the end of the conveyor system 602, the plants contained in the seed trays are harvested and the seed trays are set aside for reuse. In some embodiments, the seed trays are made out of High-Density Polyethylene (HDPE) or other plastic materials that exhibit similar properties. HDPE is non-toxic, UV resistant, water proof, and mechanically resistant to light impact. Textile layers can be added to the seed trays to fix the medium in place, which in turn improves anti-bacterial properties and aids in water absorption and retention. The seed trays cover the water below them such that sunlight does not have direct contact with the irrigation water/nutrient solution.

As illustrated in FIG. 6, a conveyor system 602 may be utilized for each respective level of the rack. In some embodiments, a single conveyor system 602 is used where seed trays not only advance along the conveyer system 602 but also change rack levels during their growth cycle. In some embodiments, the conveyor system 602 is gravity driven, using rollers to engage in sliding actions with the seed trays. The seed trays advance in position when the last seed tray in the row is removed. In some alternative embodiments, a conveyor chain is used in place of rollers.

The conveyor system 602 moves when a seed tray is being removed, so as to make space for its replacement under a first-in first-out method. At the end of the conveyor system 602, the seed trays can interact with the pick and place robot 103. A mechanism such as a linear actuator can be utilized to aid with the release of plants from the seed trays. By pushing the plant from below, the linear actuator loosens a targeted plant from the seed tray and makes it easier positionally for the pick and place robot 103 to grab the plant. Once the plant is removed from the seed tray, the loose medium can be washed away from the roots and recovered. The roots can be combed to properly fit into the gripper of the pick and place robot 103. If a basket is being used, excess roots can be arranged or trimmed.

Grow Towers and Vine Fruit Growth Systems

The farms can grow leafy greens, vine fruits, or a combination of both on the tower system. The irrigation system works in a closed loop. The water is initially purified through an inverse osmosis system. Nutrients are added and controlled through electrical conductivity and pH sensors, in conjunction with Proportional Integral Derivative (PID) controllers and peristaltic pumps. Vine fruit is grown in a conventional vine fruit hydroponic system. The pick and place robot 103 picks the fruit and trims plants as needed.

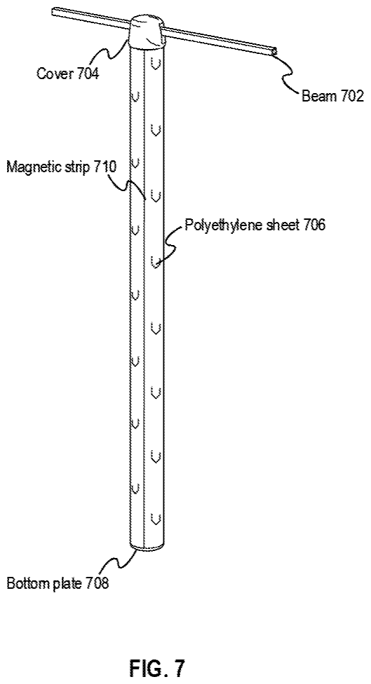

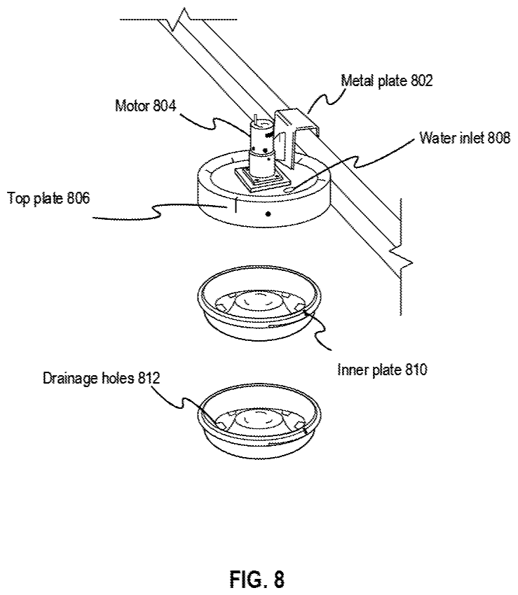

FIGS. 7 and 8 illustrate a vertical grow tower 102 as used in the micro-farm. The grow towers 102 are easy to assemble and transport. They are also cheap to manufacture, lightweight, and have safety measures to avoid leakages and algae growth. In some embodiments, the grow towers 102 are approximately 2.4 m (7.9 ft) tall, 150 mm (5.9 in) in diameter and can hold about 60 plants per tower and four plants per plate/story. Although an example embodiment has been shown and described above, the grow towers 102 are not limited to such dimensions and carrying capacity.

As illustrated in FIG. 7, the grow tower 102 is fixed to a beam 702. The tower frame 105 comprises a number of beams 702 arranged in parallel. In an embodiment, the tower frame 105 may be made of material such as steel, etc. The exterior of a grow tower 102 may include components such as, but not limited to, a cover 704, a polyethylene sheet 706, a bottom plate 708, and a magnetic strip 710. The polyethylene sheet 706 has a number of openings that serve as plant slots for plant insertion/placement and can be rolled into an elongated cylinder. The components are disclosed in more details below.

FIG. 8 illustrates the inner components of a grow tower 102, according to one embodiment. The grow tower 102 is connected to the beam 702 by a bent portion of a metal plate 802 that fixes the grow tower 102 to the beam 702 of the tower frame 105. A flat end of the metal plate 802 is fixed to a top plate 806 of the grow tower 102 to allow the grow tower 102 to suspend on the beam 702. A motor 804 is mounted to the top plate 806 with the flat end of the metal plate 802 running between the motor 804 and top plate 806. Through the motors 804, the grow towers 102 spin slowly, at the speed of approximately 2 rpm. The slow rotation allows the plants on the grow tower 102 to receive even distribution of sunlight. At locations where sunlight is scarce, the spinning/rotating allows for much needed even exposure of sunlight to promote optimized photosynthesis and growth. The motor 804 is one of a compact DC motor, a stepper motor, or a servomotor, and power to the motor 804 can be fed directly from small solar panels, from the grid, or a combination of both.

Water enters the grow tower 102 from the top plate 806 through a water inlet 808, and makes its way down through gravitational pull. The amount of water entering the grow tower 102 at any given time is relatively small. Once the water reaches the bottom, it is drained through a pipe or hose attached to the bottom plate 708. The bottom plate 708 retains some water so as to weigh down the grow tower 102 and to catch small precipitations. The top plate 806, where water is being poured into, is covered by the cover 704 to ensure that the nutrient-rich water is not exposed to sunlight at any point.

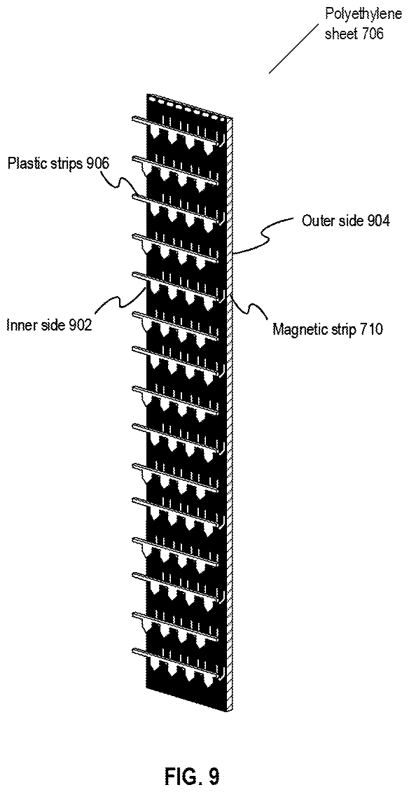

Within the rolled-up polyethylene sheet 706 are a number of inner plates 810. The inner plates 810 are custom made components having shapes resembling plates or bowls, with drainage holes 812 that allow for water drainage. The inner plates 810 are suspended in the polyethylene sheet 706 and separated by a fixed distance so as being evenly spaced. In some embodiments, the fixed distance is approximately 150 mm (5.9 in). FIG. 9 illustrates the polyethylene sheet, according to one embodiment. The inner plates 810 are covered with the co-extruded polyethylene sheet 706, which has a black inner side 902 and a white outer side 904. The polyethylene sheet 706 has regularly spaced holes/openings, at a fixed distance from the inner plates 810, for the plants to be inserted and supported, while the roots are held by the inner plates 810.

The polyethylene sheet 706 has special plastic strips 906, made of the same material, welded on the inside. The plastic strips 906 partially cover the holes on the outer side 904. This prevents the water from dripping through the holes, as well as contact from sunlight to the nutrient-rich water. This protects the system from algae growth and contamination. In addition, the plastic strips 906 also orient the roots and leaves of the inserted plants such that plants are ideally positioned for growth. In some embodiments, the special plastic strips 906 are arranged in a staggered fashion on the inner side 902 so as to provide optimal plant distribution.

The polyethylene sheet 706 is closed over the inner plates 810 with the magnetic strip 710 and held at the top. The inner plates 810 are suspended in the polyethylene sheet 706 through placement of the inner plates 810 over rows of protruding wires on the inner side 902. In alternative embodiments, the polyethylene sheet 706 can be closed by at least one of buttons, zippers, string, or welding instead of the magnetic strip 710.

Reference markings, codes, strips or other methods can be added to the grow towers 102, so as to provide unique reference to each position/slot. For example, the pick and place robot 103 might look for a particular plant in the second hall, fifth tower, third story, second position, which may have the corresponding code being (2,5,3,2). With the grow towers 102 arranged on a grid, the story is fixed. It is therefore easy to determine the position in association with the first three items. However, since the grow towers 102 are axisymmetric and are spinning, additional marking is required to identify each individual slot/opening.

In another embodiment, the grow tower 102 consists of the polyethylene sheet 706 in combination with only the top plate 806 and the bottom plate 708, with no inner plate 810 in between. These grow towers 102 can be empty or have plate-like structures made out of plastic film directly attached to the polyethylene sheet 706. For these grow towers 102, flanged hydroponic baskets may be needed to maintain the plants' positions. The plants can be placed in the grow tower 102 with naked roots, or with roots contained in a net pot. The net pot could be made of material such as plastic. In some embodiments, the net pot is a home compostable pot, with an equally eco-friendly filling/medium/substrate.

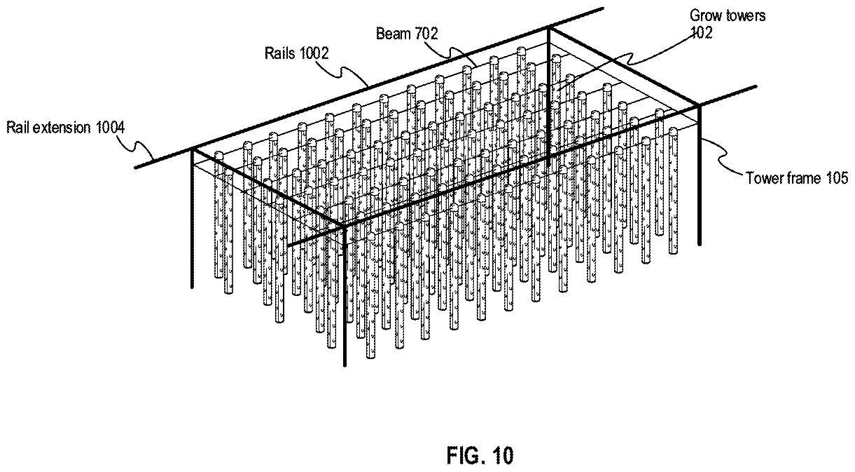

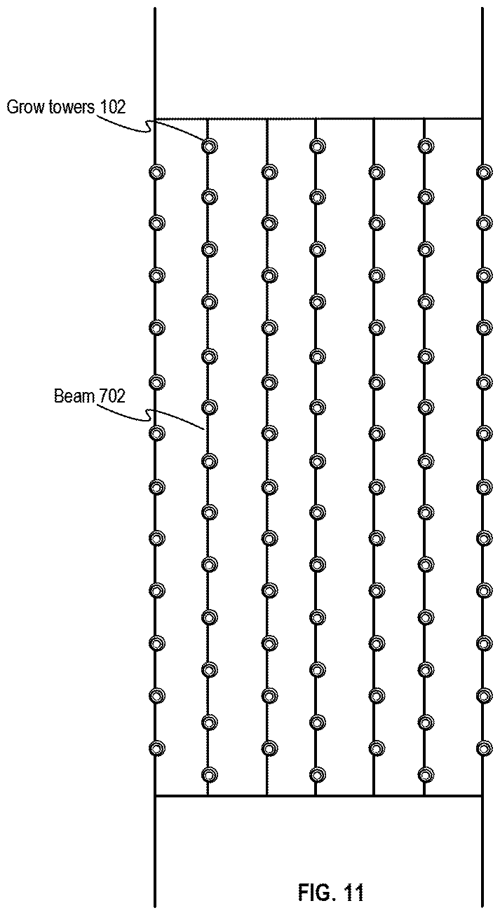

As shown in FIGS. 10 and 11, the grow towers 102 hang from the tower frame 105, which is modular and can be assembled on-site and are arranged in rows. In some embodiments, the spacing is approximately 750 mm (30 in) for two consecutive grow towers 102 which hang from the same beam 702. In some embodiments, spacing between two adjacent beams 702 is approximately 900 mm (35 in). In some embodiments, the grow towers 102 are placed in a staggered arrangement, so as to prevent blockage sunlight by one row to the next. FIG. 11 illustrates a top view of the grow towers 102 arranged in a staggered arrangement. In an embodiment, the towers are regularly arranged to form a perfect grid. FIG. 10 shows rails 1002 running above the grow towers 102 and the tower frame 105. The rails 1002 and rail extensions 1004 that extend from the ends of the rails 1002 allow the pick and place robot 103 to travel between the nursery 101, the grow towers 102, and the produce processing and packing machine 104, through a bridge of the pick and place robot 103, which will be described in more details below.

Irrigation for the grow towers 102 begin with the nutrient-rich water being pumped from a tank or reservoir upwards into the top plate 806 of the grow towers 102. The water trickles down and is collected back by the return pipes, which can be rigid PVC pipes, or a flexible return gutter, made out of the same material as the grow towers 102's cover. The advantage of the flexible gutter system is that it is lightweight, inhibits light transmission, and relatively inexpensive compared to a pipe of a similar diameter. The irrigation system can utilize either rigid water tanks, bladder tanks, a distributed water tank, etc.

A rigid tank is normally used in water installations and hydroponics. This type of tank presents a disadvantage because the return pipes run close to the ground. Therefore, the return system requires a check valve and a pump, so that water can return to the tank, but no water can flow back. This is not particularly complex, but may damage the pump if it is pumping part water and part air.

A bladder tank works just like the rigid tank system, with the exception that the tank used is made out of a resistant, yet flexible, plastic sheet or tarp. These tanks can be designed to hold a large volume of liquid while being short in height and occupying a larger footprint. The water level in these tanks will not cause leaking from backflow into the return gutters, but the tanks may require a small frame or pressurization, because an empty bladder tank with no support is prone to collapse.

A distributed tank has no central tank. It takes advantage of the large diameter required for the return gutters, and uses them to hold all the water that is required by the closed loop. The gutters are still connected at the ends and the water mixed so that nutrient control is efficient. Small pumps are located at the end of each row, and pump water up directly from the end of the gutter. A small reservoir can be added at the end to buffer water consumption. This way of administering water is efficient when footprints are small and heights are relatively low. Because no tanks are needed, the gutters are flexible and easy to install or transport and the irrigation system becomes affordable.

Pick and Place Robot

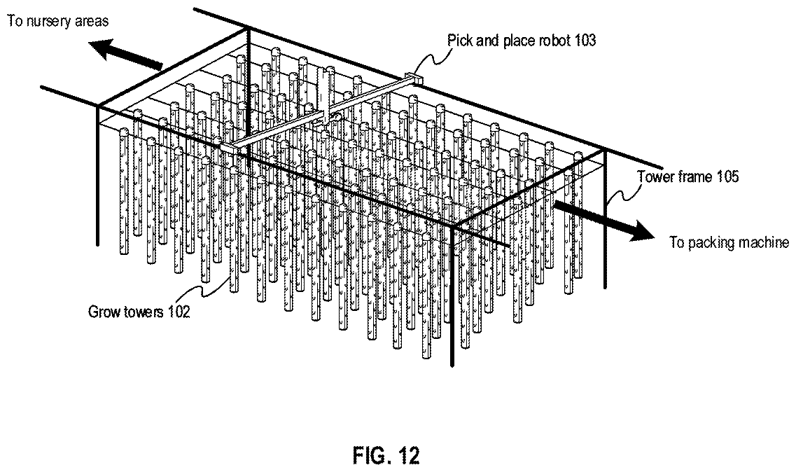

FIG. 12 illustrates an example autonomous pick and place robot 103 mounted on rails 1002 over the grow towers 102. The pick and place robot 103 can access the produce processing and packing machine 104 and the nursery 101. The pick and place robot 103 moves plants from the nursery 101 and places them into the grow towers 102. For microgreens and baby leaves, the pick and place robot 103 moves them directly from the nursery 101 to the produce processing and packing machine 104. For plants growing on the grow towers 102, the pick and place robot 103 retrieves the plants from the grow towers 102 and takes them to the produce processing and packing machine 104. The pick and place robot 103 interfaces with the produce processing and packing machine 104 by holding the plants while the roots are removed by the produce processing and packing machine 104. In an embodiment, the pick and place robot 103 possesses image recognition capabilities to assess plant quality, growth rate, weight, and other key performance indicators (KPIs).

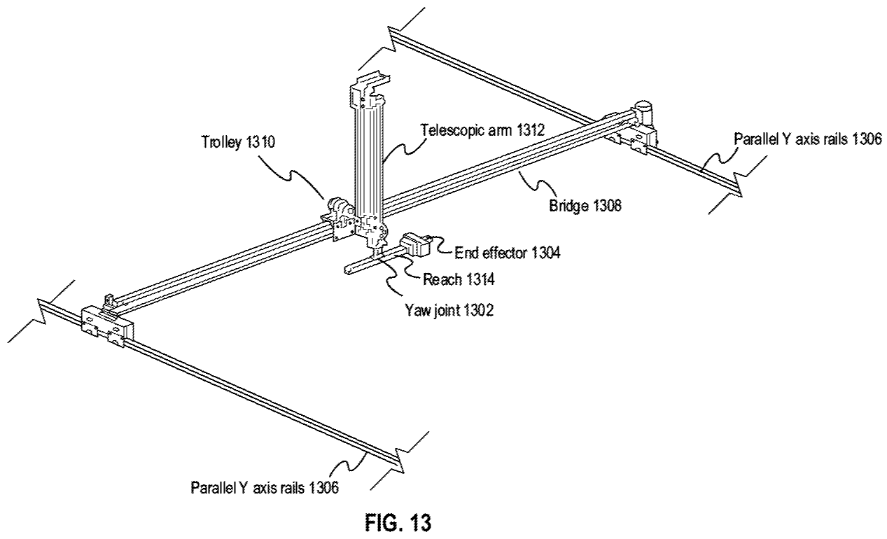

FIG. 13 illustrates components of the pick and place robot 103, in an example embodiment. The pick an d place robot 103 may be a Cartesian robot that moves in three moving directions/axes of X, Y, and Z. The pick and place robot 103 may include components such as, but not limited to, a yaw joint 1302, an end effector 1304, and may have a “reach” degree of freedom (D.O.F.). The “reach” D.O.F. allows the pick and place robot 103 to move between the nursery 101 and the packing area.

As shown in FIGS. 12 and 13, the Y axis is the longest of the three movement axes, and where the pick and place robot 103 meets the fixed structure below it. The pick and place robot 103 runs on two parallel Y axis rails 1306, mounted on motor driven wheels. The parallel Y axis rails 1306 support the entire pick and place robot 103.

As shown in FIG. 13, the X axis consists of a bridge 1308. The ends of the bridge 1308 are mounted on the motor driven wheels that operate on the parallel Y axis rails 1306 (e.g. rails 1002 and rails extensions 1004). The bridge 1308 is positioned perpendicular to the parallel Y axis rails 1306. A trolley 1310, as with any gantry crane, is mounted on and runs along the bridge 1308. In this case, the trolley 1310 is moved by a timing belt, driven by a motor which is fixed to an end of the bridge 1308.

As shown in FIG. 13, the Z axis consists of a telescoping arm 1312 mounted on the trolley 1310, which allows the pick and place robot 103 to perform diagonal movements above the grow tower 102's beams 702. It is also driven by a timing belt, which allows for both controlled upward and downward movements. A reach 1314 extends from the end of the telescopic arm 1312 and is connected by the yaw joint 1302 to the telescopic arm 1312. The yaw joint 1302's D.O.F. revolves around the Z direction and allows the pick and place robot 103 to access the grow towers 102 which are on either side, or in a position diagonal to it.

The pick and place robot 103 relies on relative encoders positioned on each motor, absolute positioning systems, absolute position servomotors, and image recognition to know and track its position at every moment. These data can be applied separately from one another or in any combination, depending on the D.O.F. being controlled.

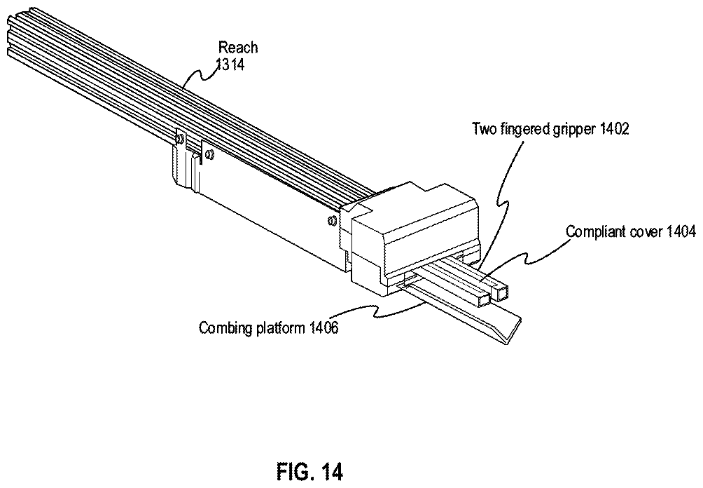

The pick and place robot 103 can have different end effectors, depending on the type of plant being grown and harvested, connected to an end of the reach 1314. The end effector 1304 can be of a two-, three-, or four-fingered gripper, with a soft compliant cover on the fingers. FIG. 14 illustrates an end effector having a two-fingered gripper 1402 with a compliant cover 1404 over the fingers, in accordance with an embodiment. This provides a firm yet delicate grasp that guarantees the plant would not be damaged when handled. The fingers can be fully compliant if a pneumatic actuator is used. The actuation can be done with servomotors, a pneumatic line, or a combination of both.

In addition to plant grasping, the end effector 1304 also has a second function, that includes a combing platform 1406 that moves back and forth, parallel to the reach axis. The combing platform 1406 is used to “comb” the roots and guide them into the grow towers 102's slots.

In some embodiments, the end effector 1304 may include shears for handling products such as tomatoes and fruits. The shears are used to trim the plants or cut the fruits' stems. The fruits are caught by an elastic basket that will catch the fruits and dampen the impact from the drop.

Produce Processing and Packing Machine

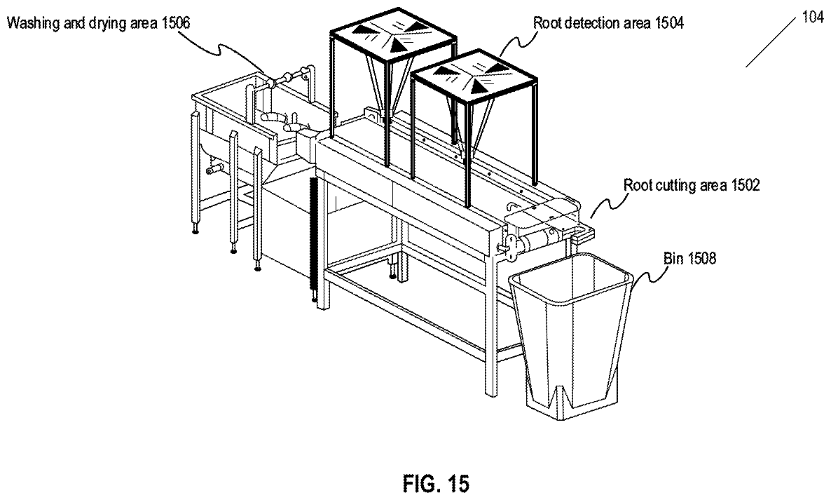

FIG. 15 illustrates an example produce processing and packing machine 104, in accordance with an example embodiment. As shown in FIG. 15, the produce processing and packing machine 104 processes the various plants and prepares them for packing. The produce processing and packing machine 104 performs the following:
1. Cuts and disposes of the roots;
2. Uses an AI algorithm that:
   (a) Detects the plant's species (so as to make salads or simply check the order is correct);
   (b) Based on a scoring system, removes the leaves that may be, for any reason, undesirable;
3. Washes and disinfects the leaves with ozone micro-bubbles, Ultraviolet C (UVC) rays and/or low temperature water, so as to cool the leaves;
4. Dries the leaves by air-blowing and/or a centrifuge; and
5. Packs the salad or greens in an eco-friendly package and adds other ingredients in the package.

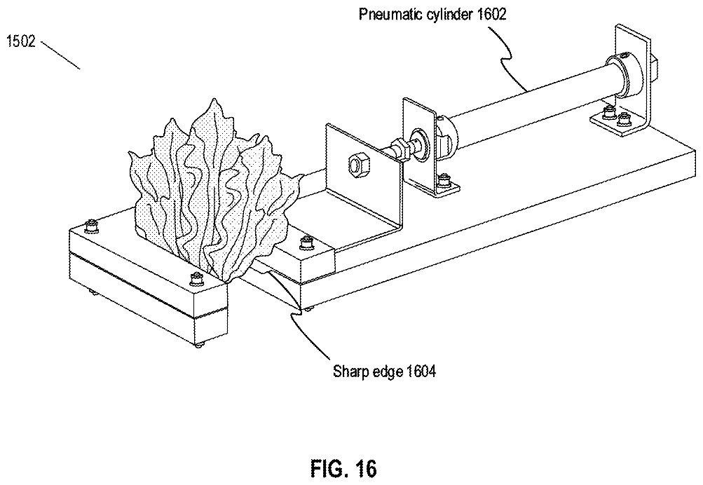

The produce processing and packing machine 104 first cuts and disposes of the roots of the plants at a root cutting area 1502. The produce processing and packing machine 104, depending on the type of plant, uses a cutter such as, but not limited to, a circular saw, oscillating toothed saw, or a sharp edge to cut off the roots. Electric motors and/or small pneumatic cylinders that provide force application are used in conjunction with the cutter to perform the cutting action. The cut is performed just below the end effectors 1304's gripping position, which serves both stability and guiding purposes in making the cut. FIG. 16 shows an example root cutting area 1502, in accordance with an example embodiment. As illustrated in FIG. 16, the root cutting area 1502 comprises a pneumatic cylinder 1602 affixed with a sharp edge 1604.

After the roots are removed and collected by a bin 1508, using information-monitoring devices such as a camera, a stereo camera, etc., the produce processing and packing machine 104 determines the type of plant being examined at a detection area 1504. The detection area 1504, using a scoring system, determines the quality of each leaf. The position and center of mass of each leaf is then detected. A small/compact robot, such as a Delta™ uses a vacuum end effector to grasp each leaf that passes the scoring system and moves it to a washing and drying area 1506. The grasping process utilizes the determined position and center of mass associated with each leaf to perform leaf grasping. Inferior leaves that do not pass the grading on the scoring system are discarded.

At the washing and drying area 1506, the grasped leaves are washed by being submerged in water with temperature of approximately 4° C. Through the water, a small amount of ozone is bubbled to guarantee cleanliness. In some embodiments, UVC rays and a diluted non-toxic solution can also be used. Since the system has no soil, there is no mud or dirt present. After washing, the leaves are transferred to a centrifuge to remove excess water and the leaves are brought to a packaging area. Cool air can be blown across the centrifuge to speed and enhance the water removal process.

The packaging process starts after the leaves have been washed and dried. The leaves and vegetables are either packed in single serve containers with carrying capacity up to 300 g or 400 g, or in batch containers of several plants. Both package types are eco-friendly, home compostable, water resistant, and impact resistant. The direct-to-consumer, or single serve containers, have a transparent cover that allows the consumer to see the packaged product.

The containers can be made of material such as polyethylene terephthalate (PET) plastic. PET plastic, having good mechanical properties, is great for food preservation and can be easily recycled. In another embodiment, the containers may be made of renewable or compostable materials such as polylactic acid (PLA), bamboo paste, palm leave, etc. The containers may have rigid, semi-rigid lids, or a thermally-sealed plastic film. The plastic film may have micro-pores to avoid condensation and fogging. An inert gas, such as nitrogen, may be used to fill the container and extend the products' shelf life.

### Climate Control

1. Air drying

Due to high insulation, the micro-farm disclosed can use systems such as HVAC, AC, etc., to provide efficient heating. Nonetheless, the desired system is one where air-drying is performed at a constant temperature while simultaneously adding humidity, with constant enthalpy. This produces a quick descent in temperature, making it the most ideal cooling method for the micro-farm. Air can be dried in a number of ways, such as heating, liquid desiccants, etc.

In one embodiment, air is dried beyond its dew point by means of a heat pump. Condensation is removed from the air to a drain or reservoir. The air is reheated so that it can reach the desired temperature.

In another embodiment, humidity control is achieved through application of liquid desiccants. A solution of approximately 30% concentration calcium chloride in water is used. This solution, when in contact with air, will readily dilute itself by absorbing moisture. The solution is forced in contact with air, typically in the form of small droplets, to dry the air through air crossflow.

The solution is then heated, which can be performed using at least one of fuel, a heat pump, electrical resistance, a solar collector, etc. Once the solution is heated, it is again set in a crossflow path with air, this time from the outside. In this stage, the solution is cooled and concentrated again. The solution can be cooled further if required.

This process runs in a closed loop, where water or salt can be added to correct excess concentration or dilution. The added benefit of drying air this way is that calcium chloride is a non-toxic bactericide. The water-air crossflow acts as a filter for suspended particles and the salt cleans the air from any biological contaminant that might be present. The cooling process can be done with an AC system, but it can also be done by adding water to previously dried air.

2. Cooling

The cooling process can be achieved with the installation of an AC system, but it can also be accomplished by adding water to previously dried air. This method has a very fast and effective cooling effect. In some embodiments, water can be added to sprinklers for release perform cooling.

In an embodiment, evaporative pads are utilized in the cooling process, where air is blown through water retaining pads. This involves low power consumption, but implies taking air in from the outside of the micro-farm.

In another embodiment, ultrasonic water foggers are utilized for cooling. This consists of arrays of high frequency piezoelectric discs, covered with a silicone membrane, submerged in water. The oscillation of these discs produces very small droplets of liquid water to form on the surface. These droplets are light enough to, by means of a small fan, be blown into the environment. The heat used for these droplets to evaporate is given by the air and produces the cooling effect. This technique produces a fast and homogeneous humidification and natural additives can be placed in the water for different effects (pest control, air purification, etc.)

3. Heating

Heating is performed by means of insulation and incident solar radiation retention. In places where winters or temperatures are extreme, HVAC systems can be installed. The air brought in from outside can be preheated and water re-circulation systems can be used, especially during night-time. In addition to solar radiation, solar collectors can be used to preheat the air and thereby diminish power consumption.

The water recirculation heating method utilizes solar power and thus reduces power consumption. Water recirculation consists of black pipes which are placed on the inner surface of the internal insulation of the greenhouse. These pipes act as coils and are exposed to sunlight. Water is pumped through these pipes during the day-time for the sun to heat them. When radiation declines, the water is stored in a thermally-insulated reservoir. During the night, water is pumped out again. The water cools down while warming up the greenhouse. This process can be assisted with conventional heating in case of extreme conditions.

### Backup Systems

Backup systems ensure that the vertical micro-farm does not suffer from component failures that may lead to operation failures of the micro-farm. Backup systems include, but are not limited to, backup power supplies, redundant water tanks, and redundant fans. Backup power supplies such as power generators, batteries, etc., guarantee the continued micro-farm operation during a power outage. Whereas redundant water tanks are provided as backup water source in the event of primary water tank failure. Similarly, redundant fans keep the structure inflated in the event of a fan failure.

The foregoing example embodiments may have various benefits and advantages. For example, the vertical micro-farm provided herein is both cost-efficient and highly scalable. Variously, operations of the micro-farm can be performed autonomously without manual/human operation. In addition, the lightweight design and small footprint allow the vertical micro-farm to be installed on a wide variety of surfaces.

Although a few example embodiments have been shown and described, these example embodiments are provided to convey the subject matter described herein to people who are familiar with this field. It should be understood that the subject matter described herein may be implemented in various forms without being limited to the described example embodiments. The subject matter described herein can be practiced without those specifically defined or described matters or with other or different elements or matters not described. It will be appreciated by those familiar with this field that changes may be made in these example embodiments without departing from the subject matter described herein as defined in the appended claims and their equivalents.

What is claimed:

1. A vertical micro-farm system, the system comprising:
an external structure;
a nursery positioned inside the external structure for an initial growth process;
a plurality of grow towers inside the external structure for a second growth process;
an autonomous robot configured to move baby plants from the nursery to the plurality of grow towers after completion of the initial growth process; and
a produce processing and packing machine for receiving matured plants for processing after the baby plants have completed the second growth process in the plurality of grow towers,
wherein the matured plants are transferred from the plurality of grow towers to the produce processing and packing machine by the autonomous robot.

2. The system of claim 1, wherein the external structure comprises:
an outer dome, wherein the outer dome comprises at least one plastic film;
a floor, wherein the floor is joined to the outer dome; and
a double door airlock that allows entrance into the vertical micro-farm.

3. The system of claim 2, further comprising:
a frame, wherein the frame comprises sealed inflatable beams; and
an insulation layer, wherein the insulation layer comprises two layers of plastic films, with a first plastic film layer tangent to an inner side of the frame and a second plastic film layer tangent to an outer side of the frame,
wherein a still air gap is created between the two layers of plastic films to provide insulation to the vertical micro-farm system.

4. The system of claim 1, wherein the nursery comprises:
a conveyor system for receiving seed trays arriving at the nursery, wherein each seed tray contains seeds; and
a growth system, wherein the growth system is an area of the nursery that cultivates the seeds through the initial growth process, wherein the seeds grow into the baby plants on completion of the initial growth process.

5. The system of claim 1, wherein each of the plurality of grow towers comprises:
a top plate;
a bottom plate;
a plastic sheet, wherein the plastic sheet is rolled into an elongated cylinder with the top plate attached to a first opening of the elongated cylinder and the bottom plate attached to a second opening of the elongated cylinder;
a plurality of inner plates, wherein the plurality of inner plates is positioned inside the elongated cylinder and evenly spaced,
wherein the plastic sheet has a plurality of slots for baby plants to be inserted, and
wherein the plurality of inner plates provide support for roots of baby plants inserted into the plurality of slots.

6. The system of claim 5, wherein each of the plurality of grow towers further comprises:
a water inlet formed on the top plate, wherein water is pumped from a tank or a reservoir into the top plate through the water inlet to perform irrigation.

7. The system of claim 5, further comprising:
at least one tower frame;
a plurality of rails running above the at least one tower frame; and
a plurality of rail extensions extending from ends of the plurality of rails to allow the autonomous robot to travel between the nursery, the plurality of grow towers, and the produce processing and packing machine,
wherein the at least one tower frame comprises a plurality of beams that are parallelly arranged.

8. The system of claim 7, wherein the plurality of grow towers is arranged in a staggered fashion on the plurality of beams.

9. The system of claim 8, wherein each of the plurality of grow towers further comprises a motor connected to the top plate, wherein the motor rotates associated grow tower to allow plants on the associated grow tower to receive even distribution of sunlight to promote optimized photosynthesis and growth.

10. The system of claim 7, wherein the autonomous robot comprises:
a bridge with motor driven wheels that operate on the rails and the rail extensions, wherein the bridge is positioned perpendicular to the rails and the rails extensions;
a trolley that is mounted on and moves along the bridge;
a telescopic arm that is mounted on the trolley, wherein the telescopic arm provides upward and downward movements for the autonomous robot;
a yaw joint connected to an end of the telescopic arm;
a reach that extends from the end of the telescopic arm through the yaw joint; and
an end effector connected to an end of the reach, wherein the end effector performs plant grasping.

11. The system of claim 10, wherein the end effector comprises a fingered gripper having a plurality of fingers, with compliant cover on the plurality of fingers.

12. The system of claim 1, wherein the produce processing and packing machine comprises:
a root cutting area for removing roots of the matured plants;
a detection area for determining plant type associated with each of the mature plants, and determining leaf quality of each leaf of the matured plants;
a washing and drying area for:
for each leaf having leaf quality that passes a scoring threshold, washing and drying each leaf; and
for each leaf having leaf quality that does not pass the scoring threshold, discarding each leaf; and
a packing area for packing washed and dried leaves into one of a single serve container or a batch container.

13. A method for growing and harvesting plants in a micro-farm, the method comprising:
receiving seed trays at the micro-farm, wherein each seed trays contains seeds;
feeding the seed trays into a nursery, and growing the seeds to baby plants at the nursery;
transferring, by an autonomous robot, the baby plants from the nursery to at least one grow tower, wherein the baby plants grow into the plants at the at least one grow tower; and
transferring, by the autonomous robot, at least one of the plants from the at least one grow tower to a produce processing and packing machine for harvesting.

14. The method of claim 13, wherein transferring at least one of the plants from at least one grow tower to the produce processing and packing machine for harvesting comprises:
receiving an order at the micro-farm; and
picking, by the autonomous robot, at least one of the plants that corresponds to the order from at least one grow tower to the produce processing and packing machine.

15. The method of claim 14, wherein the order is an order for a salad.

16. The method of claim 13, transferring the baby plants from the nursery to the at least one grow tower comprises:
grasping, by the autonomous robot, the baby plants from the nursery; and
inserting, by the autonomous robot, the baby plants into a plurality of slots associated with the at least one grow tower.

17. The method of claim 16, wherein transferring at least one of the plants from the at least one grow tower to the produce processing and packing machine for harvesting comprises:
grasping, by the autonomous robot, the at least one of the plants from the at least one grow tower to the produce processing and packing machine;
removing, by the produce processing and packing machine, roots of the at least one of the plants;
determining, by the produce processing and packing machine, plant type of the at least one of the plants;
determining, by the produce processing and packing machine using a scoring system, leaf quality of each leaf of the at least one of the plants;
for each leaf that passes a scoring threshold, washing and drying each leaf; and
for each leaf that does not pass the scoring threshold, discarding each leaf.

18. The method of claim 17, wherein transferring at least one of the plants from the at least one grow tower to the produce processing and packing machine for harvesting further comprises packing washed and dried leaves into one of a single serve container or a batch container.

19. The method of claim 13, wherein the nursery comprises:
a conveyor system for:
receiving the seed trays arriving at the nursery; and
transporting the seed trays to a growth system,
wherein the growth system cultivates the seeds through an initial growth process, and
wherein the seeds grow into the baby plants on completion of the initial growth process.
